(19) United States
(12) Patent Application Publication
(10) Pub. No.: US 2012/0092266 A1
(43) Pub. Date: Apr. 19, 2012

(54) Method and Apparatus for Providing a Navigation Path on a Touch Display of a Portable Device

(75) Inventor: Venkata S. Akella, Sunnyvale, CA (US)

(73) Assignee: Motorola Mobility, Inc., Libertyville, IL (US)

(21) Appl. No.: 12/904,996

(22) Filed: Oct. 14, 2010

(51) Int. Cl. G06F 3/041

(52) U.S. Cl. 345/173

(57) ABSTRACT

The application discloses a method and apparatus for providing a navigation path at a portable device. The method includes receiving a continuous sequence of touch inputs at the touch display. The touch display includes at least a source location and a destination location. The method then includes determining the source location based on a first touch input of the continuous sequence of touch inputs, and determining the destination location based on a second touch input of the continuous sequence of touch inputs. The method further includes mapping the continuous sequence of touch inputs between the source location and the destination location with corresponding path coordinates, and displaying the navigation path, at the touch display, between the source location and the destination location based on the corresponding path coordinates.

### FIELD OF THE DISCLOSURE

The present disclosure relates generally to a portable device and more particularly to a method and apparatus for providing a navigation path on a touch display of the portable device.

### BACKGROUND

It is known for a portable device to provide a user interface and a display screen from which a user may activate, initiate or launch various applications, functions, modes of operation, etc. The applications may include maps applications and/or other similar applications that provide a view of a geographical map, also known as maps view, on the display screen of the portable device.

In a conventional portable device, the user typically uses keypads to launch the maps application. In addition, the user provides information, such as a source address and a destination address, using the keypads for obtaining a corresponding maps view and directions on the display screen. However, for providing such information, the user has to enter text multiple times on the tiny display. Thus, entering the text by using such keypads is difficult, time consuming, and tedious. Also, entering the text manually using keypads, and limited display size may cause more errors in the text messages or addresses. In many portable devices, entering the text or other data is made difficult by the size and/or organization of the user interface.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a portable device displaying a map screen in accordance with some embodiments.

FIG. 2 depicts a display arrangement of selecting locations on a map screen in accordance with some embodiments.

FIG. 3 is a schematic diagram illustrating the internal components of the portable device in accordance with some embodiments of the invention.

FIG. 4 depicts a display arrangement of selecting location icons in accordance with some embodiments.

FIG. 5 depicts a display arrangement of selecting contacts from a contact list in accordance with some embodiments.

FIG. 6 depicts a display arrangement of a map screen displaying a navigation path in accordance with some embodiments.

FIG. 7 is a flowchart of a method for providing a navigation path on a touch display of a portable device in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method, steps and components related to providing a navigation path from a source location to a destination location on a touch display of a portable device. The present disclosure is directed towards a method and apparatus for providing a navigation path at the portable device. The method includes receiving a continuous sequence of touch inputs at the touch display. The touch display includes at least a source location and a destination location. The method then includes determining the source location based on a first touch input of the continuous sequence of touch inputs, and determining the destination location based on a second touch input of the continuous sequence of touch inputs. The method further includes mapping the continuous sequence of touch inputs between the source location and the destination location with corresponding path coordinates, and displaying the navigation path, at the touch display, between the source location and the destination location based on the corresponding path coordinates.

In the description herein, numerous specific examples are given to provide a thorough understanding of various embodiments of the invention. The examples are included for illustrative purpose only and are not intended to be exhaustive or to limit the invention in any way. It should be noted that various equivalent modifications are possible within the spirit and scope of the present invention. One skilled in the relevant art will recognize, however, that an embodiment of the invention can be practiced with or without the apparatuses, systems, assemblies, methods, components mentioned in the description.

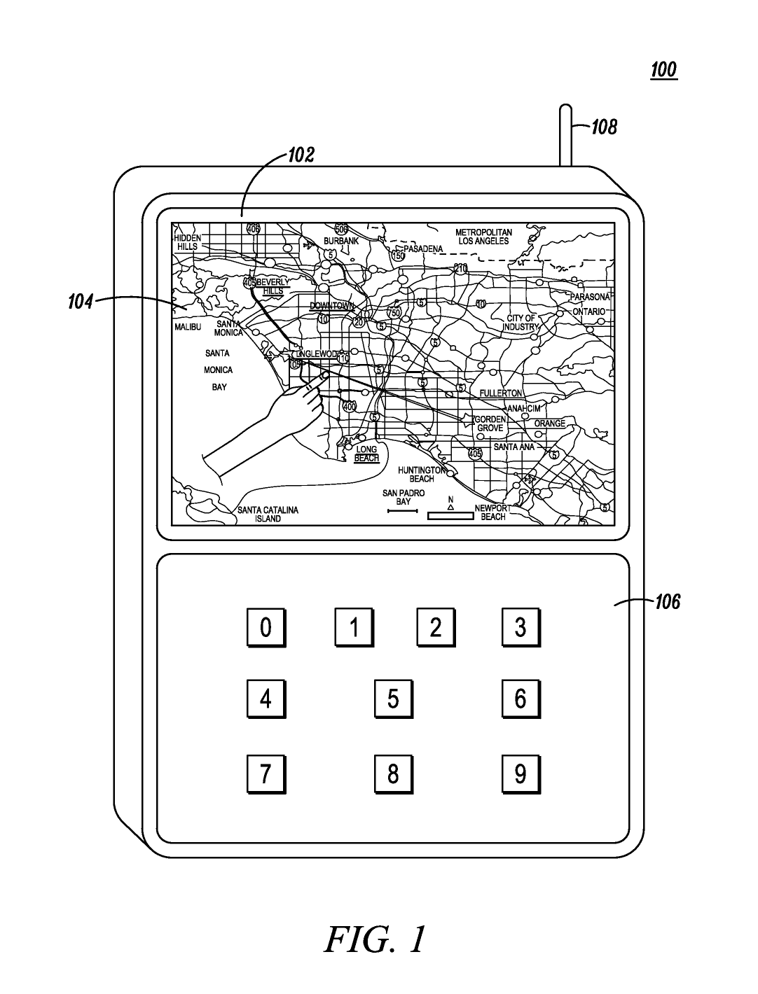

FIG. 1 illustrates a portable device 100 displaying a map screen 104 in accordance with some embodiments. The portable device 100 includes a display 102, one or more input keys such as keypad 106, and an antenna 108.

In accordance with an embodiment, the display 102 may be a touch display that includes a touch-sensitive surface overlaying the display. The display may show a particular map screen 104 when a user launches a maps application on the portable device 100 in response to contact to the touch-sensitive surface. For example, the user may select an icon associated with the maps application, using the touch display 102 or the keypad 106 for obtaining the map screen 104. The map screen 104 is defined as a screen that displays a visual image of a geographic area. It should be noted that the display 102 may be any type of display, and is not limited to the touch display.

Further, the maps application is an application that provides a view of geographic locations on the map screen 104 of the portable device 102. For example, the user may select a map screen of Los Angeles, and a map view of geographic locations such as L.A. International Airport, Disneyland®, Anaheim, Beverly Hills, Inglewood, etc. of Los Angles are displayed on the map screen 104, as depicted in FIG. 1. It should be noted that, throughout the description, the map screen 104 of Los Angeles is considered as an example for easy understanding of the invention, and any geographic area may be considered and/or displayed on the map screen.

In accordance with the embodiment, the map screen 104 displays a plurality of locations that includes at least a source location and a destination location. The source location may be a geographic location that the user desires to have as a starting point of a navigation path. Similarly, the destination location may be a geographic location that the user desires to have as an ending point of the navigation path. For example, on the map screen 104 of Los Angeles, the source location may be the L.A. International Airport, where the user wishes to start the journey, and the destination location may be the Disneyland® where the user wishes to end the journey. Further, the navigation path may be any path that provides a driving route or a walking route from the source location to the destination location on the map screen of the touch display.

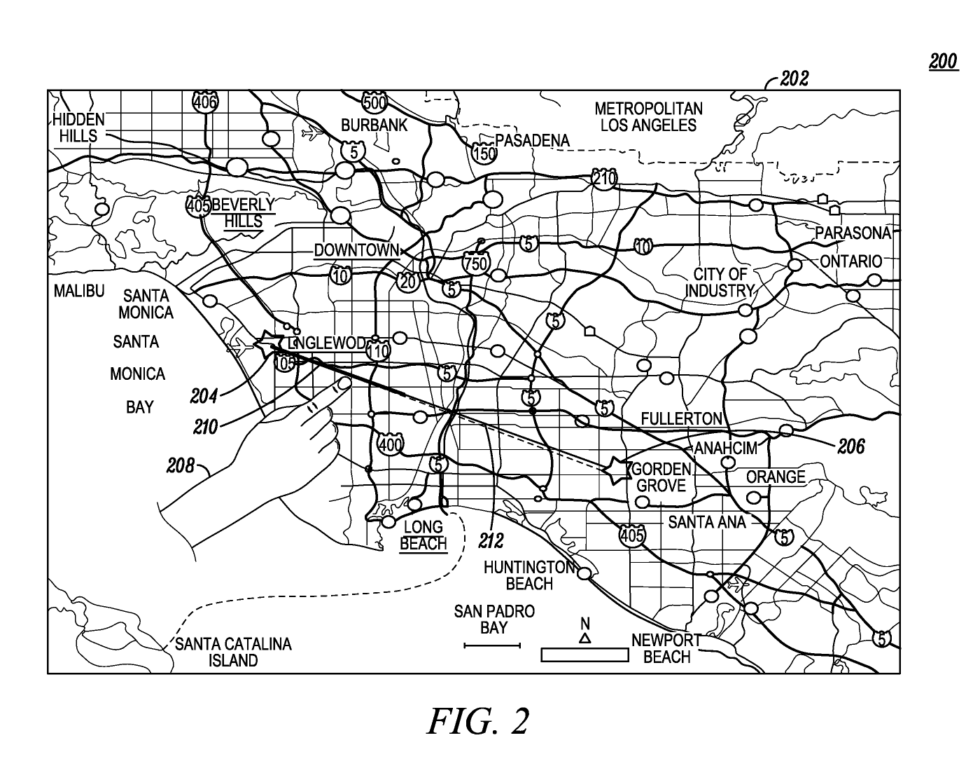

In accordance with the embodiment, upon displaying the plurality of locations on the touch display, the user may provide a continuous sequence of touch inputs 210 on the touch display, as depicted in FIG. 2. The continuous sequence of touch inputs 210 represents a substantially continuous and linear line 212 between the source location 204 and the destination location 206. For example, in the map screen 202 of Los Angeles, the user may draw a line from the source location 204, e.g., L.A. International Airport, to the destination location 206, e.g., Disneyland®, providing the continuous sequence of touch inputs 210 to the portable device.

The continuous sequence of touch inputs 210 may include a first touch input identifying the source location 204, and a second touch input identifying the destination location 206. The first touch input may be a single contact input of the continuous sequence of touch inputs 210, in which the single contact input is associated with a discrete position where contact with the touch-sensitive surface and/or display is initiated. Similarly, the second touch input may be a single release input of the continuous sequence of touch inputs 210, in which the single release input is associated with a discrete position where contact with the touch-sensitive surface and/or display is terminated, e.g., a user lifts his or her finger from the touch display. The continuous sequence of touch inputs 210 may be provided by continuous contact of at least one of a stylus or a finger at the touch display. For example, the continuous sequence of touch inputs may be provided by gliding the finger 208, the stylus, or any similar device on the touch display from the source location 204 to the destination location 206, as depicted in FIG. 2.

In accordance with the embodiment, the received continuous sequence of touch inputs 210 are mapped with corresponding path coordinates associated with the navigation path from the source location 204 to the destination location 206. The path coordinates are pre-stored data, of the maps application, that is associated with a plurality of navigation paths at the touch display. The plurality of navigation paths includes the navigation path connecting the source location 204 and the destination location 206 at the touch display. For example, the map screen 202 may display the plurality of locations that are interconnected by navigation paths that are associated with corresponding path-coordinates. When the user selects the locations, such as the source location 204 and the destination location 206, on the map screen 202, the corresponding path-coordinates are identified, and the navigation path, associated with the corresponding path coordinates, are displayed on the touch display. Thus, the user is obtaining the navigation path and the direction of the path, on the touch display without entering text or addresses at the portable device.

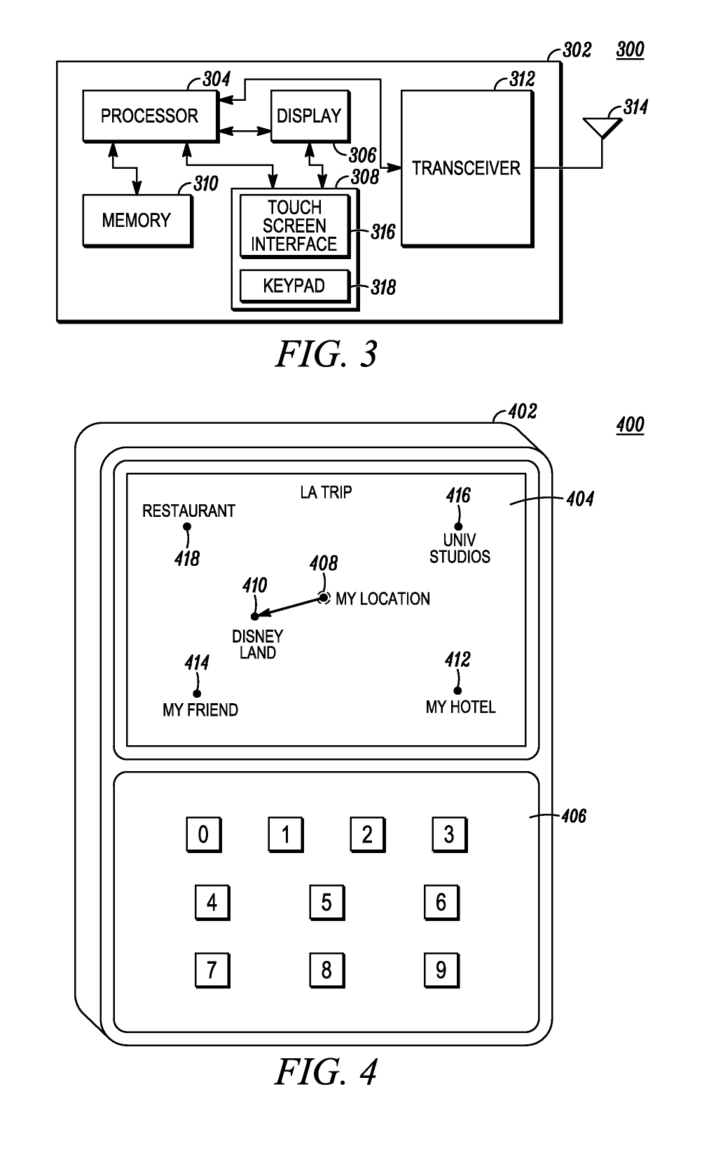

FIG. 3 is a schematic diagram illustrating the internal components of the portable device 300 in accordance with some embodiments of the invention. The exemplary components include a housing 302, a processor 304, a display 306, a memory 310, a user interface 308, a transceiver 312, and an antenna 314.

In accordance with the embodiment, the antenna 314 comprises any known or developed structure for radiating and receiving electromagnetic energy in the frequency range containing the wireless carrier frequencies. The antenna 314 is used for transmitting radio signals associated with a continuous sequence of touch inputs to a remote device (not shown). Further, the antenna 314 is used for receiving corresponding path coordinates from the remote device, in response to sending the continuous sequence of touch inputs.

In accordance with the embodiment, the transceiver 312 coupled between the processor 304 and the antenna 314 enables the portable device 300 to transmit and receive the RF signals through the antenna 314. In accordance with the embodiment, the transceiver 312 converts the RF signals received from the antenna 314 to digital data for use by the processor 304.

In accordance with the embodiment, the processor 304 supported by the housing 302 is coupled to the transceiver 312, the memory 310, the display 306, and the user interface 308. The processor 304 operates in conjunction with the data and instructions stored in the memory 310 to control the operation of the portable device 300. The processor 304 may be implemented as a digital signal processor, hard-wired logic and analog circuitry, or any suitable combination of these.

In accordance with the embodiment, the memory 310 is coupled to the processor 304 to store data and instructions for the operation of the processor 304. The memory 310 maintains a database that stores the information about the continuous sequence of touch inputs provided by the user, and a plurality of path coordinates corresponding to the continuous sequence of touch inputs. The memory 310 may also store RF signals and associated data, such as path coordinates, received from the remote device.

In accordance with the embodiment, the user interface 308, coupled to the processor 304, includes at least a touch-screen interface 316 and a keypad 318. The touch-screen interface 316 is communicably coupled to the display 306, e.g., touch display, for accessing the content on the display unit 306. For example, the user may select a portion of the content on the display 306 with a stylus or finger. The portion of the content may be selected by continuous contact of at least one of a stylus or a finger at the touch display 306. The touch-screen interface may also be used for launching the maps application. For example, the user may select an icon on the touch display for launching the maps application.

Further, the keypad 318 is used as an input device for providing information to the portable device 300. For example, the user may use the keypad 318 for selecting an icon, associated with the maps application, on the non-touch display of the portable device 300.

In accordance with the embodiment, the portable device 300 includes the display 306 that is communicably coupled to the processor and the user interface 308. The display 306 may include touch screens, non-touch displays, or a combination of touch and non-touch displays. The display 306 may have multiple displays of same or different sizes and resolutions. The display 306 may display screens that are physically different screens, multiple virtual screens on a single physical screen, or any combination of the previous. Further, each screen may display one or more applications for the user.

In accordance with an embodiment, the display 306 may display a plurality of locations including the source location and the destination location. The locations may be displayed as a visual image on the map screen. The visual image includes at least one of an image, an icon, or an alphanumeric character, sensitive to at least one of the continuous sequence of touch inputs, at the touch display. The user may select the locations on the display 306 for obtaining the navigation paths between them. Further, upon selecting the locations, the display 306 may display a map screen with the navigation path between the source location and the destination location.

Operationally, the user interface coupled to the display 306, receives a continuous sequence of touch inputs when the user draws a line on the display 306. The display may be a touch display that displays at least the source location and the destination location. The continuous sequence of touch inputs represents a substantially continuous and linear line between the source location and the destination location.

Upon receiving the continuous sequence of touch inputs, the processor 304 determines the source location based on a first touch input of the continuous sequence of touch inputs. The first touch input is a single contact input at the touch display 306. Also, the processor 304 determines the destination location based on a second touch input of the continuous sequence of touch inputs. The second touch input is a single release input at the touch display 306. Further, the processor 304 may also determine intermediate locations between the source location and the destination location based on a third touch input. The third touch input may be any single touch input provided after the first touch input and before the second touch input. For example, the third touch input may be a single sliding input in which contact to the touch-sensitive surface and/or display is continuous immediately before and after the third touch input, in contrast to the single contact input of the first touch input and the single release input of the second touch input. It should be noted that the terms first, second, and third touch inputs are simply used for differentiating different touch inputs, and is not limited to a specific number or order of the touch inputs.

After determining the source location and the destination location, the processor 304 maps the continuous sequence of touch inputs between the source location and the destination location with corresponding path coordinates. The processor 304 compares the received sequence of touch inputs with a plurality of path coordinates store in the memory 310. The plurality of path coordinates is associated with a plurality of navigation paths at the touch display 306. The plurality of navigation paths includes the navigation path connecting the source location and the destination location at the touch display.

The processor 304 then identifies the corresponding path coordinates associated with the navigation path, from the plurality of path coordinates based on the continuous sequence of touch inputs.

In another embodiment, the processor 304 may map the continuous sequence of touch inputs by sending, via a transceiver 312, the continuous sequence of touch inputs to a remote device. In response to sending the continuous sequence of touch inputs, receiving the corresponding path coordinates from the remote device. Further, the processor 304 identifies the navigation path at the touch display based on the received path coordinates.

In accordance with the embodiment, upon identifying the navigation path, the processor 304 displays the navigation path, at the touch display 306, between the source location and the destination location based on the corresponding path coordinates. The touch display 305 also provides the direction of travel along with the navigation path. Thus, the user is provided with the navigation path between the source location and the destination location without entering text or address at the portable device 300.

FIG. 4 depicts a display arrangement of selecting location icons in accordance with some embodiments. The portable device 400 includes a display unit 404, and a keypad 406. The display unit 404 may be a touch display that displays a plurality of geographic locations 408, 410, 412, 414, 416, 418. The locations 408-418 are displayed as a visual image including at least one of a graphic image, an icon, or an alphanumeric character. The icons or images displayed on the touch display are sensitive to at least one of the continuous sequence of touch inputs at the touch display.

In accordance with the embodiment, the user may add a list of geographic locations 408-418 at the portable device 400. The locations 408-418 may be arbitrarily positioned on the touch-display 404 when the user launches maps application. Further, the user may select the locations 408-418 by drawing a line between them. For example, the user may draw a line from “my location” icon 408 to the “Disneyland” icon 410. The line may be represented as a continuous sequence of touch inputs provided by the user on the touch-display 404. In this example, the first touch input of the continuous sequence of touch inputs selects “my location” icon 408, and thus “my location” is determined as a source location. Similarly, the last touch input selects the “Disneyland” icon 410, and thus it is considered as the destination location.

Further, upon drawing the line, the processor obtains the geographic location information of both the source location and the destination location. For example, the processor may obtain the residential/physical address of the user associated with the “my location” icon 408. Similarly, the processor may obtain the residential/physical address of the Disneyland® associated with the “Disneyland” icon 410.

After obtaining the location information of the source location and the destination location, the processor maps the sequence of touch inputs with corresponding path coordinates to identify a navigation path that connects the source location and the destination location. Finally, the processor launches a map screen on the touch-display 404, and displays the navigation path connecting the source location and the destination location. For example, the map screen of Los Angeles is launched, and the navigation path from the residential place of the user to the Disneyland® is shown on the touch-display 404.

In accordance with another embodiment, in response to the second touch input (such as, for example, when a user lifts his or her finger from the touch display), the display may show a destination indicator associated with the destination at the position of the second touch input. For example, as shown in FIG. 4, the destination indicator “Disneyland” is shown as an icon and associated with the position of the icon. Also, in response to the second touch input, if there is no particular destination associated with the position of the second touch input (for example, a geographical area such as a mountain or body of water), the display may show one or more suggested destinations near the position. The suggested destinations may be further filtered or sorted based on previous touch inputs before being displayed or in response to a user input at the touch display. Further, in response to the second touch input, the display may show one or more location indicators associated with preferences of a particular use. For example, the display may show dots or icons associated with friend locations, identified by an address book or device locations (GPS and the like), or interesting places.

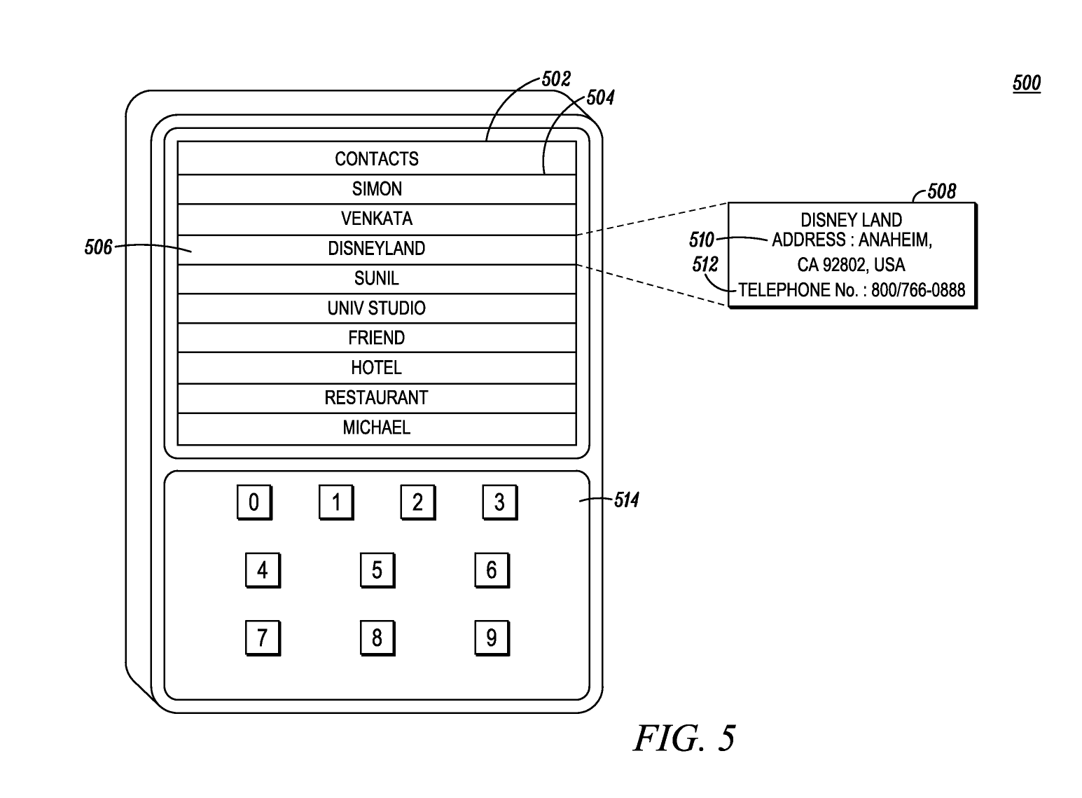

FIG. 5 depicts a display arrangement of selecting contacts from a contact list in accordance with some embodiments. A portable device 500 includes a display unit 502 and a keypad 514. The display unit 502 displays a list of contacts 504 such as Simon, Venkata, Disneyland®, Sunil, Universal Studios®, Friend, Hotel, Restaurant, Michael etc. It should be noted that the list of contacts 504 is not limited with the above contacts, and it can have any number of contacts and/or sub-lists. Further, each contact includes pre-stored information such as name 508, address 510, contact number 512 etc. that is used for determining geographic/physical address of the location associated with the corresponding contacts.

Operationally, the user may select the contacts from the list of contacts 504 displayed on the display 502. Each contact is associated with a location and also includes address associated with the location. For example, the user may select “Venkata” as a first contact, and “Disneyland” as a second contact. Upon selecting the contacts, the processor considers the location associated with the first contact as a source location, and the location associated with the second contact as a destination location.

Further, the processor obtains a first address associated with the source location, and a second address associated with the destination location. For example, the processor obtains the address 510 such as “Anaheim, Calif. 92802, USA” associated with the destination location “Disneyland” 506.

After obtaining the first address and the second address, the processor determines a navigation path that connects the destination location from the source location. For example, the navigation path may be an optimized path used for driving a car from the source location “Venkata” to the destination location “Disneyland” 506.

In accordance with the embodiment, the processor then launches the maps application showing the navigation path along with a direction on the display 502 of the portable device 500.

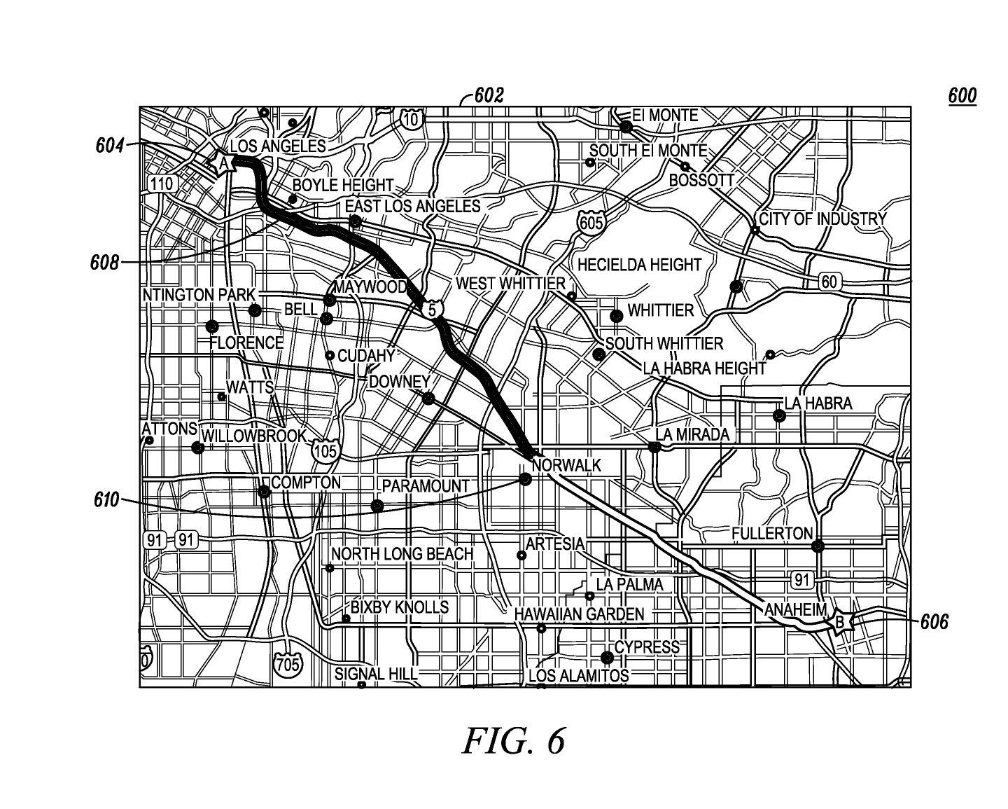

FIG. 6 depicts a display arrangement of a map screen 602 displaying a navigation path 608 in accordance with some embodiments. The map screen 602 displays a geographic view of Los Angeles. It should be noted that the map screen 602 of Los Angeles is considered for easy understanding of the invention, and the map screen 602 of any geographic area may be considered.

In accordance with the embodiment, the user selects the locations such as Los Angeles 604 and Anaheim 606 by drawing a line 610 from Los Angeles 604 to Anaheim 606 on the touch-display 600. The user may also select intermediate locations such as Norwalk 610 via which the user desires to travel to Anaheim 606. The line may be a continuous sequence of touch inputs received by the touch interface of the device. The continuous sequence of touch inputs may represents a substantially continuous and linear line between the source location and the destination location.

Upon receiving the continuous sequence of touch inputs, the processor determines the source location, e.g., Los Angeles 604, from the first touch input of the continuous sequence of touch inputs, and the destination location, e.g., Anaheim 606, from the last touch input of the continuous sequence of touch inputs. Further, the processor maps the received sequence of touch inputs with corresponding path coordinates stored in the memory of the portable device. In another embodiment, the processor may send the continuous sequence of touch inputs to a remote device. The remote device determines the corresponding path coordinates, and sends it to the portable device.

After determining the path coordinates, the processor identifies the navigation path 608 associated with the path coordinates, and the identified navigation path 608 is finally displayed on the map screen 602 of the touch-display 600. Thus, the user is obtaining the navigation path 608 between the desired locations without entering the text or address at the portable device.

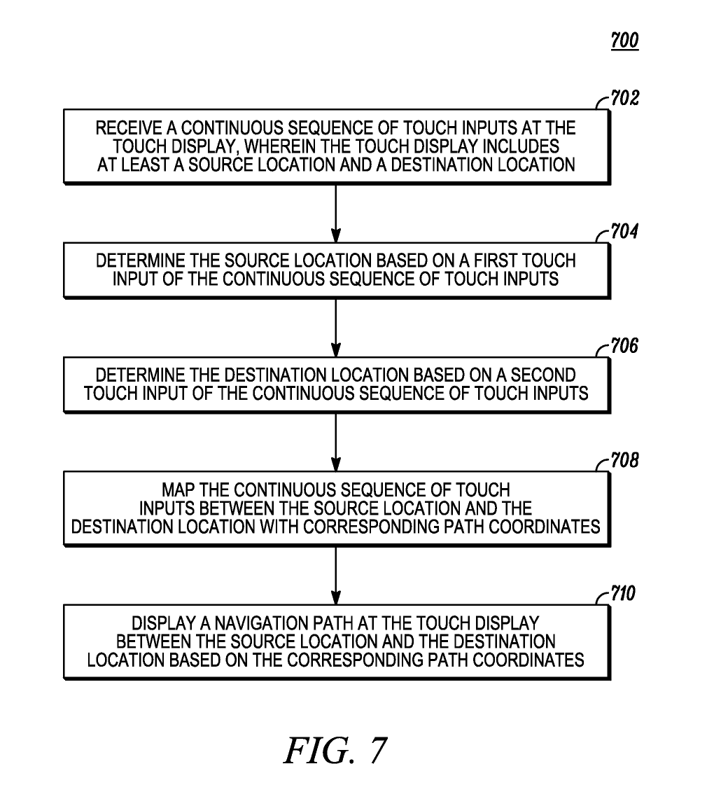

FIG. 7 is a flowchart of a method for providing a navigation path from a source location to a destination location on a touch display of a portable device in accordance with some embodiments. Referring to FIG. 7, the method 700 begins with a step of receiving 702 a continuous sequence of touch inputs at the touch display. The touch display displays a plurality of locations including at least the source location and the destination location. The continuous sequence of touch inputs represents a substantially continuous and linear line between the source location and the destination location. The touch display receives the continuous sequence of touch inputs by continuous contact of at least one of a stylus or a finger at the touch display.

Upon receiving the continuous sequence of touch inputs, the method 700 moves to a step of determining 704 the source location based on a first touch input of the continuous sequence of touch inputs. The first touch input is a single contact input at the touch display. The first touch input is received when the user touches the touch display to draw a line, connecting locations, on the touch display.

The method 700 then moves to a step of determining 706 the destination location based on a second touch input of the continuous sequence of touch inputs. The second touch input is a single release input at the touch display. For example, the second touch input may be considered as the release from contact with the touch-sensitive surface and/or display by the user after last single touch input. For another example, the second touch input may be considered as the last single contact input that the user touches the touch-display while drawing the line. Further, the user may provide any number of touch inputs, between the first touch input and the second touch input, to select any number of intermediate locations. For example, with reference to FIG. 6, the user may provide a third touch input to select an intermediate location such as “Norwalk” positioned between the source location “Los Angeles” and the destination location “Anaheim.”

In accordance with the embodiment, the method 700 continuous with a step of mapping 708 the continuous sequence of touch inputs between the source location and the destination location with corresponding path coordinates. The processor stores a plurality of path coordinates associated with a plurality of navigation paths at the touch display. The plurality of navigation paths includes the navigation path connecting the source location and the destination location at the touch display. The processor then identifies the corresponding path coordinates, associated with the navigation path, from the plurality of path coordinates based on the continuous sequence of touch inputs.

In another embodiment, the processor may send, via a transceiver, the continuous sequence of touch inputs to a remote device. The processor, in-turn, receives the corresponding path coordinates in response to sending the continuous sequence of touch inputs. The processor then identifies the navigation path at the touch display based on the received path coordinates. Yet in another embodiment, the processor may obtain a first address associated with the source location based on the first touch input of the continuous sequence of touch inputs. Similarly, the processor obtains a second address associated with the destination location based on the second touch input of the continuous sequence of touch inputs. The processor then determines the navigation path including direction, connecting the destination location from the source location, based on the first address and the second address.

Further, moving back to the method 700, the method 700 continues with a step of displaying 710 the navigation path, at the touch display, between the source location and the destination location based on the corresponding path coordinates. In addition, the processor identifies direction of the navigation path from the source location to the destination location, and the processor may display the navigation path including the direction on the touch display.

In the foregoing specification, specific embodiments have been described. The benefits of providing the navigation path on the touch display include ease of access to the maps application and obtaining navigation path without entering text or addresses on the portable device. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized controllers (or “controlling devices”) such as microcontroller, customized controllers and unique stored program instructions (including both software and firmware) that control the one or more controllers to implement, in conjunction with certain non-controller circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject

Those skilled in the art will appreciate that the above recognized advantages and other advantages described herein are merely exemplary and are not meant to be a complete rendering of all of the advantages of the various embodiments of the present invention.

We claim:

1. A method for providing a navigation path from a source location to a destination location on a touch display of a portable device, the method comprising:
receiving a continuous sequence of touch inputs at the touch display, wherein the touch display includes at least the source location and the destination location;
determining the source location based on a first touch input of the continuous sequence of touch inputs;
determining the destination location based on a second touch input of the continuous sequence of touch inputs;
mapping the continuous sequence of touch inputs between the source location and the destination location with corresponding path coordinates; and
displaying the navigation path, at the touch display, between the source location and the destination location based on the corresponding path coordinates.

2. The method of claim 1, further comprising displaying a map screen at the touch display before receiving the continuous sequence of touch inputs.

3. The method of claim 1, wherein the continuous sequence of touch inputs represents a substantially continuous and linear line between the source location and the destination location.

4. The method of claim 1, wherein the continuous sequence of touch inputs includes the first touch input identifying the source location, and the second touch input identifying the destination location.

5. The method of claim 1, wherein receiving the continuous sequence of touch inputs comprises:
receiving the first touch input associated with the source location, wherein the first touch input is a single contact input at the touch display;
receiving the second touch input associated with the destination location, wherein the second touch input is a single release input at the touch display; and
receiving at least a third contact input after the first touch input and before the second touch input at the touch display.

6. The method of claim 1, wherein the touch display displays a plurality of locations including the source location and the destination location.

7. The method of claim 6, wherein at least one of the locations is associated with corresponding contact information stored in the portable device before receiving the continuous sequence of touch inputs at the touch display.

8. The method of claim 7, wherein the at least one of the locations is identified based on selecting the corresponding contact information displayed at the touch display.

9. The method of claim 6, wherein each of the locations is displayed as at least one of an image, an icon, or an alphanumeric character, sensitive to at least one of the continuous sequence of touch inputs at the touch display.

10. The method of claim 1 further comprising:
selecting an intermediate location based on a third touch input of the continuous sequence of touch inputs, wherein the third touch input is received after the first touch input and before the second touch input of the continuous sequence of touch inputs; and
displaying the navigation path, at the touch display, between the source location and the destination location through the intermediate location based on the mapped path coordinates.

11. The method of claim 1, wherein mapping the continuous sequence of touch inputs comprises:
storing a plurality of path coordinates associated with a plurality of navigation paths at the touch display, wherein the plurality of navigation paths includes the navigation path connecting the source location and the destination location at the touch display; and
identifying the corresponding path coordinates, associated with the navigation path, from the plurality of path coordinates based on the continuous sequence of touch inputs.

12. The method of claim 1, wherein mapping the continuous sequence of touch inputs comprises:
sending, via a transceiver, the continuous sequence of touch inputs to a remote device;
receiving the corresponding path coordinates in response to sending the continuous sequence of touch inputs; and
identifying the navigation path at the touch display based on the received path coordinates.

13. The method of claim 1, wherein mapping the continuous sequence of touch inputs comprises:
obtaining a first address associated with the source location based on the first touch input of the continuous sequence of touch inputs;
obtaining a second address associated with the destination location based on the second touch input of the continuous sequence of touch inputs; and
determining the navigation path including direction, connecting the destination location from the source location, based on the first address and the second address.

14. The method of claim 1, wherein displaying the navigation path comprises:
identifying direction of the navigation path from the source location to the destination location; and
displaying the navigation path including the direction on the touch display.

15. A portable device for providing a navigation path from a source location to a destination location, the portable device comprising:
a device housing;
a touch display supported by the housing, the touch display displaying at least the source location and the destination location;
an user interface supported by the housing, the user interface receiving a continuous sequence of touch inputs at the touch display; and
a processor supported by the housing and coupled to the touch display and the user interface, the processor determining the source location based on a first touch input of the continuous sequence of touch inputs and the destination location based on a second touch input of the continuous sequence of touch inputs, the processor further mapping the continuous sequence of touch inputs between the source location and the destination location with corresponding path coordinates on the map screen,
wherein the touch display displays the navigation path between the source location and the destination location based on the corresponding path coordinates.

16. The portable device of claim 15, further comprising a memory supported by the housing and coupled to the processor, the memory storing contact information associated with a plurality of locations displayed on the touch display, and storing a plurality of path coordinates associated with a plurality of navigation paths on the map screen, wherein the plurality of navigation paths includes the navigation path connecting the source location and the destination location on the map screen.

17. The portable device of claim 15, further comprising a transceiver supported by the housing and coupled to the processor, the transceiver sending the continuous sequence of touch inputs to a remote device, and receiving the corresponding path coordinates in response to sending the continuous sequence of touch inputs.

18. The portable device of claim 15, wherein the touch display receives the continuous sequence of touch inputs by continuous contact of at least one of a stylus or a finger at the touch display.

19. The portable device of claim 15, wherein the touch display displays a plurality of contact information associated with at least the source location and the destination location.

20. The portable device of claim 15, wherein the touch display displays the navigation path that indicates at least a driving route connecting the source location and destination location.

21. The portable device of claim 15, wherein the touch display displays at least the source location and the destination location as a visual image on the map screen, wherein the visual image includes at least one of an image, an icon, or an alphanumeric character, sensitive to at least one of the continuous sequence of touch inputs, at the touch display.
